(19) United States
(12) Patent Application Publication
(10) Pub. No.: US 2008/0179554 A1
(43) Pub. Date: Jul. 31, 2008

(54) Dispensing Gun Valve Member And Dispensing Gun Formed Therewith

(76) Inventor: Clifford J. Finn, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 11/668,226

(22) Filed: Jan. 29, 2007

(51) Int. Cl. F16K 47/00

(52) U.S. Cl. 251/122

(57) ABSTRACT

A valve member for use in a dispensing gun and a dispensing gun. The valve member has a valve body, a metering portion located downstream of the valve body, and a seal located downstream of the valve body. The dispensing gun includes a body, a passageway formed in the body, an inlet at an upstream end of the passageway, a valve seat at a downstream end of the passageway, a valve member that engages the valve seat at a metering interface, and a seal that blocks the passageway downstream of the metering interface when the valve member is in the closed position.

### CROSS-REFERENCE TO RELATED APPLICATIONS

Not Applicable.

### STATEMENT REGARDING FEDERALLY SPONSORED RESEARCH

Not Applicable.

### FIELD OF THE INVENTION

This invention relates to a valve member, and more particularly to an improved valve member for a gun used to dispense fluid components.

### BACKGROUND OF THE INVENTION

Manually operable guns are known for dispensing fluids. For example, one type of gun dispenses settable urethane foam. In operation, separate fluid components are fed individually to the gun, passed separately through valve members, and brought into contact with each other upon reaching a mixing chamber of a nozzle. The mixed components are then discharged from the nozzle as foam. Examples of such guns are found in U.S. Pat. Nos. 4,311,254 and 4,399,930 issued to Gary Harding, in U.S. Pat. No. 4,762,253 issued to Steven Palmert, and in U.S. Pat. No. 5,462,204 issued to Clifford Finn.

In foam-dispensing guns, two fluid components are typically used and commonly referred to as the “A resin” and the “B resin.” The A and B resins usually consist of polymeric isocyanate and polyol amine, respectively. The components are supplied separately in two pressurized containers that are attached by hoses to inlets of the guns. When the two fluid components or resins are mixed, the mixture quickly forms a rigid foam product that is substantially insoluble and extremely difficult to remove from surfaces with which it comes in contact. As a result, the valve members and valve seats within the nose of the gun body are designed to have a tight fit in order to force all of the A resin and B resin into the nozzle when the valve members are in the closed position.

It is also important to keep the components separate within the gun so that their only contact is in the mixing chamber of the disposable nozzle. Furthermore, the A resin, has a tendency to harden on exposure to air. As a result, should either the two components mix within the valve members or the A resin be exposed to air, the valve members would clog and cease to correctly operate.

The use of economical, durable plastic as the preferred material for many components of a dispensing gun has presented additional challenges. It has become apparent that costly secondary operations are often required to manufacture certain components because of manufacturing tolerances and material variations. Variations arise due to uneven shrinkage of the plastic, weld lines within the formed plastic, flashing caused by the forming process, and the like. All of these factors create inconsistencies and irregularities in the fit of mating components of a dispensing gun.

The metering interface between the valve member and the valve seat is of particular concern. If the valve member does not both expel substantially all of the resin into the nozzle and create an airtight seal between itself and its seat, closing off the resin from the nozzle, the components of the gun may clog and become unusable or operate at less than the desired level. Therefore, the increased use of plastics to form the metering interface between the valve member and valve seat has created a practical problem, which previous designs have proven inadequate at resolving.

### SUMMARY OF THE INVENTION

The invention is advantageous in that it provides an improved valve member and dispensing gun that prevents set up or hardening of components within the metering interface such that the metering interface remains free of contaminants and is consistently operable at peak design parameters.

Another advantage of the invention is substantially to expel fluids from the metering interface, and to prevent contaminants or fluids from entering the valve seats from downstream when the valves are in the closed position, despite inconsistencies and irregularities in the metering interface (e.g., valve seats and valve members).

Additional advantages and features of the invention will become apparent from the description that follows. In the description, reference is made to the accompanying drawings, which illustrate preferred embodiments of the invention and do not limit the scope of the invention as stated in the claims.

### BRIEF SUMMARY OF THE DRAWINGS

FIG. 1 is an elevation view of a foam-dispensing gun incorporating an embodiment of the present invention;

FIG. 2 is a horizontal section view taken in the plane of line 2-2 of FIG. 1;

FIG. 3 is a vertical section view taken in the plane of line 3-3 in FIG. 2;

FIG. 4 is a partial vertical section view taken in the plane of line 4-4 in FIG. 2;

FIG. 5 is a view similar to FIG. 4 but showing a dispensing gun in an open position;

FIG. 6 is an elevation view of a preferred embodiment of the present invention;

FIG. 7 is a perspective view of the preferred embodiment of FIG. 6;

FIG. 8 is an alternative embodiment of the present invention;

FIG. 9 is a partial section view of an alternative embodiment of the present invention; and

FIG. 10 is a partial perspective view of another alternative embodiment of the present invention.

### DETAILED DESCRIPTION OF THE PREFERRED EMBODIMENTS

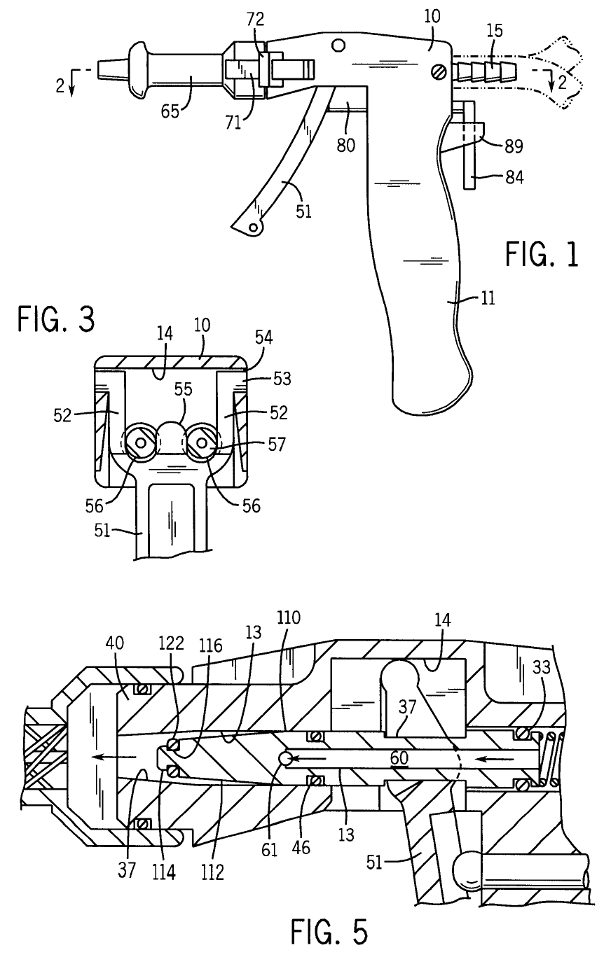

The improved valve member and dispensing gun will be discussed, without limitation, in relation to a foam-dispensing gun incorporating two valve members 31. One skilled in the art will appreciate the multitude of alternative configurations that do not exceed the scope of the present invention. Referring to FIGS. 1-5, the foam-dispensing gun includes a body 10 with a handle 11 that may be formed integral with the body 10. The body 10 and handle 11 may be molded from a synthetic resin material, plastic material, or the like. The body 10 is formed with a pair of longitudinal, parallel passageways 12, 13. The passageways 12, 13 are divided into downstream and upstream portions by an intermediate chamber 14.

The upstream portions of the passageways 12, 13 mount brass connectors 15 that have a ribbed end for attachment to hoses connected to pressurized containers for fluid components that are used to form the foam. The connectors 15 are held in place in the body 10 by setscrews 16 extending transversely to the passageways 12, 13 and received in annular recesses 17 in the connectors 15. The connectors 15 each have a second annular recess 18 interior of the body 10. The second annular recess 18 mounts an O-ring 19 that seals with the upstream portion of the passageway 12, 13.

Brass bushings 22 are mounted in the passageways 12, 13 downstream of the connectors 15. The bushings 22 include annular recesses 23 to mount O-rings 24 that seal with the upstream portions of the passageways 12, 13.

As shown in FIG. 4, the connectors 15 are hollow and define inlets leading from the tanks of the fluid components. The bushings 22 are also hollow and mount duckbill valves 25 in their center. The duckbill valves 25 are formed of a rubber or other elastomeric material and function as one-way valves to permit fluid under pressure to enter a passageway 12, 13. The duckbill valves 25 will close to seal off the inlets when a higher backpressure is applied to the exterior of the duckbill valves 25.

Each bushing 22 is disposed against a bellville spring 26 that bears against an end of the respective connector 15 thereby urging the bushing 22 downstream in the passageway 12, 13 until it abuts against a shoulder 27. A coiled spring 30 is disposed in each of the passageways 12, 13. The spring 30 bears at one end against an end of a respective bushing 22. The other ends of the springs 30 bear against the ends of valve members 31 (discussed in more detail below) also disposed in the passageways 12, 13.

The chamber 14 mounts a yoke 50 formed at the top of a trigger lever 51. The yoke 50 has a pair of arms 52 terminating in lateral bosses 53 that are received for pivotal movement in holes 54 in the two sides of the body 10, as shown in FIG. 3. The yoke 50 also includes a central rib 55 which, with the arms 52, defines two spaced cradles 56 that receive necked down portions 57 intermediate the ends of the valve members 31. The springs 30 normally urge the valve members 31 downstream into the closed position, as shown in FIG. 4. The trigger lever 51 can be rotated to withdraw the valve members 31 against the urgings of the springs 30 to urge the valve members 31 to the open position, as shown in FIG. 5.

Each valve member 31 has an internal passage 60 that terminates in a transverse port 61 disposed upstream of the metering portion 41 (discussed in more detail below) and extends to the surface of the valve member 31. As shown in FIG. 5, when the trigger lever 51 is squeezed to open the valves, fluid from the pressurized containers can pass through the internal passages 60 in the valve members 31, out the ports 61, through the valve seats 37, and out of the front nose 40 of the body 10.

A disposable nozzle 65 is mounted on the nose 40. The nozzle 65 has a hollow interior that defines a mixing chamber 66 and an outlet 67. A helical static mixer 68 of known construction is mounted in the mixing chamber 66. The upstream end of the nozzle 65 has an enlarged circular cylindrical portion 69 that surrounds the nose 40 of the body 10 and is sealed thereto by an O-ring 70. A pair of resilient arms 71 extend along either side of the nozzle 65 rearwardly from the enlarged cylindrical portion 69. The resilient arms 71 are adapted to engage ears 72 that extend from opposite sides of the body 10 adjacent the nose 40. The resilient arms 71 have a curved portion 73 adjacent their ends, which terminate in a notch 74, that mate with an ear 72. The nozzle 65 can be quickly attached to, or removed from, the body 10 by sliding the resilient arms 71 beneath the ears 72.

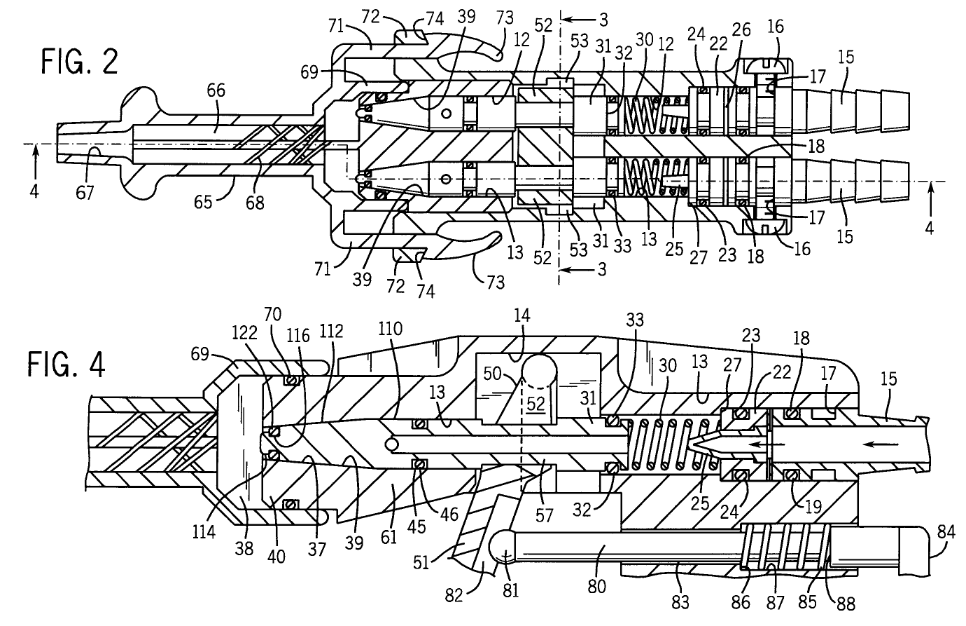

The static mixer 68 includes a wall portion 76 that is located in the open inlet chamber defined by the enlarged cylindrical portion 69 of the nozzle 65. As shown in FIG. 2, the wall portion 76 divides the inlet chamber and is positioned between the valve seats 37 so that complete mixing of the two fluid components does not occur immediately at the nose 40.

A safety can be provided to prevent the accidental movement of the trigger 51. The safety comprises a rod 80 having a bulbous end 81 that rides in a channel 82 along the inside of the trigger lever 51. The rod 80 is supported in a bore 83 in the handle 11 and terminates in a transverse handle 84. A spring 85 is disposed between a shoulder 86 formed by a counterbore 87 and a shoulder 88 on the rod 80. Although the safety is shown and described, the safety can be omitted without departing from the scope of the invention.

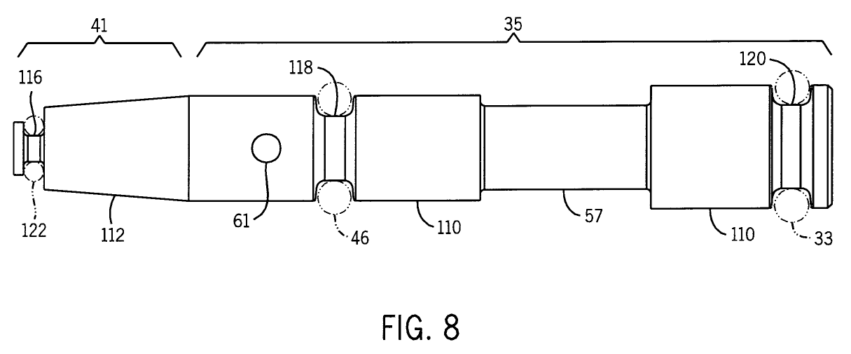

With the general structure of the foam-dispensing gun described, an embodiment of the valve member 31 of the invention will be discussed in greater detail with reference to FIGS. 2, 4, 6, 7, and 8. It is of note that the valve members 31 of the present invention are suitable for use in more than the described foam-dispensing gun and have applicability to all types of dispensing guns, whether metering fluids or other substances, and whether having one valve member 31 or multiple within the body 10 of the dispensing gun. With this in mind, we turn our attention to the structure and use of a preferred embodiment of a valve member 31 of the present invention.

In general, the valve member 31 meters the flow of fluid from the connected upstream tanks (not shown). As previously noted, when in the closed positions, shown in FIG. 4, the valve members 31 block the flow of fluids, and when in the open positions, shown in FIG. 5, allow fluids to pass through the valve seats 37, which open directly through the front face of the nose 40, and into the nozzle 65.

The valve members 31 of the preferred embodiment include two main sections, namely, a valve body 35 and a metering portion 41 downstream of the valve body 35. In the preferred embodiment, the valve body 35 includes two seals, an upstream seal and a downstream seal. The upstream seal is preferably comprised of an upstream cylindrical portion 110 having an upstream annular recess 120 with an upstream O-ring 33 seated therein. The upstream seal prevents fluid from traveling downstream past the upstream end of the valve body 35. The downstream seal is preferably comprised of a downstream annular recess 118 with a downstream O-ring 46 seated therein. The downstream seal prevents fluid from traveling upstream of the downstream end of the valve body 35 and into the chamber 14. Both the upstream and downstream seals act to prevent contaminants from entering into the fluid passageways 12, 13 from the chamber 14.

The metering portion 41 of the valve member 31 extends downstream from the valve body 35 of the preferred embodiment. The metering portion 41 mates with a valve seat 37 to establish a metering interface 39 used to meter the flow of fluid through the passageways 12, 13 and creates a seal blocking the respective passageway 12, 13 downstream of the metering interface when the valve member 31 is in the closed position.

In the preferred embodiment, the metering portion 41 has a frusto-conical portion 112 that mates with a substantially matching valve seat 37 formed in the nose 40 of the body 10. An O-ring 122 is seated in the metering annular recess 116 creating a seal downstream of the metering interface 39 between the frusto-conical portion 112 and the valve seat 37 when the valve is closed, as shown in FIGS. 2 and 4. As the valves are closed, the frusto-conical portion 112 and O-ring 122 will urge the fluid downstream out of the metering interface 39 despite variations in the metering interface 39, specifically the valve members 31 and the valve seat 37. The mating of the frusto-conical portion 112 in the valve seat 37 combined with the O-ring 122 will block the interior of the passageways 12, 13 and prevent contaminants from reaching the fluids in the passageways 12, 13 and prevent expelled fluids from traveling upstream and back into the passageways 12, 13. Advantageously, the seal prevents the atmosphere or fluid from entering the metering interface 39 from the downstream end, despite inconsistencies and irregularities in the valve seats 37 and valve members 31. As a result, binding of the valve members 31 within the valve seats 37 is reduced, if not eliminated, and manufacturing tolerances for the valve members 31 and mating valve seats 37 can be significantly relaxed as compared to the prior art. Although the metering interface 39 disclosed herein includes the frusto-conical portion 112 mating with the frusto-conical valve seat 37, the metering interface can take other forms, such as a conical portion mating with an sharp edge without departing from the scope of the invention.

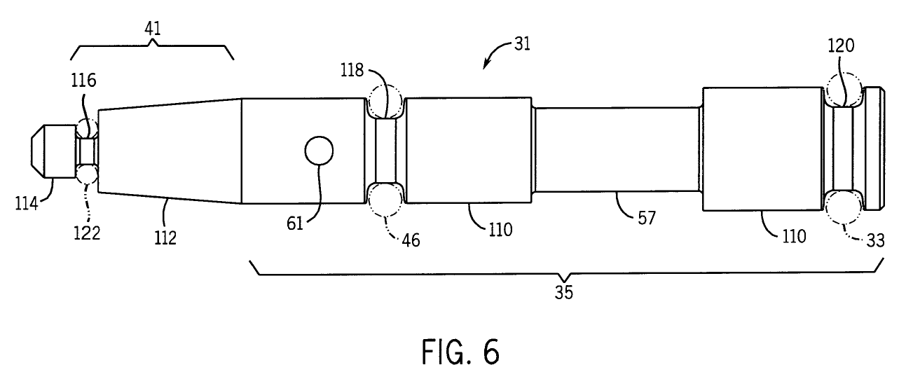

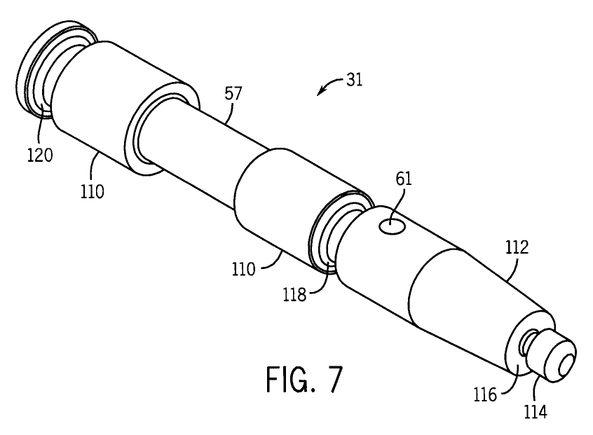

As shown in FIGS. 6 and 7, a cylindrical portion 114 extending downstream of the metering portion 41 may be provided downstream of the O-ring 122. This cylindrical portion 114 helps to expel fluid from the metering interface 39 prior to the influence of the O-ring 122 and mating metering portion 41 and valve seat 37. In this embodiment, the metering annular recess 116, in which the O-ring 122 is seated, is disposed downstream of the metering portion 41 and upstream of the cylindrical portion 114. Preferably, the metering annular recess 116 and O-ring 122 are located downstream of the metering portion 41. This placement helps to ensure that substantially all of the fluid has been expelled from the metering interface 39, thus preventing the hardening of fluids and contamination of the metering interface 39.

While the embodiment depicted in FIGS. 6 and 7 incorporates a cylindrical portion 114, the O-ring 122 may be seated in a metering annular recess 116 disposed anywhere downstream of the valve body 35 and remain within the scope of the present invention.

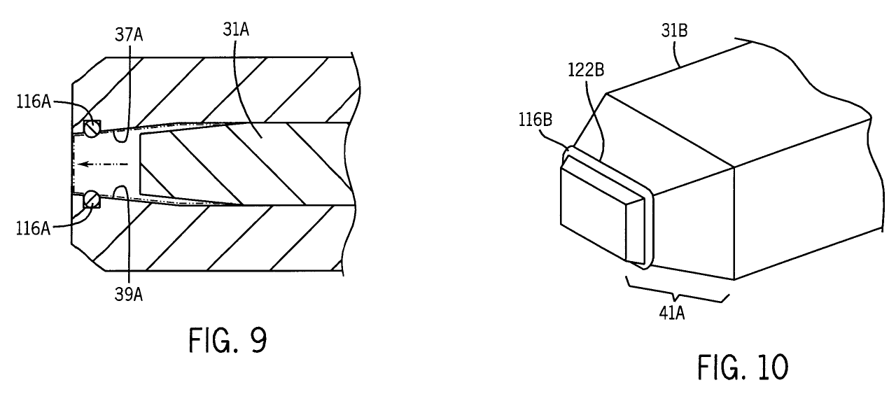

Furthermore, the valve members 31 need not have a cylindrical cross-section. As shown in FIGS. 9 and 10, embodiments of the present invention may incorporate polygonal cross sections, a combination of circular and polygonal cross-sections, and other cross-sections without exceeding the scope of the present invention.

Furthermore, turning to FIG. 9, a further embodiment of the seal made at the metering interface 39A is depicted. In this embodiment, the metering annular recess 116A is formed in the valve seat 37A and not in the valve member 31A. However, the seal is still formed as the valve member 31A is mated with the valve seat 37A to form the metering interface 39A. The fluid within the valve seat 37A is expelled from the metering interface 39A and the same advantages as indicated in relation to the previous embodiments are realized.

An alternative valve member 31B is illustrated in FIG. 10. In this embodiment, the valve member 31B has a rectangular cross-section. The metering portion 41A is also rectangular in cross-section and has a rectangular metering recess 116B in which a rectangular sealing ring 122B is seated. Again, this embodiment provides similar advantages and only represents one of the numerous variations of the present invention that fall within the scope hereof.

The valve members 31 are preferably made of brass, but may be made of other metals, plastics, composites, and the like. Advantageously, with the development of the present invention, the valve members 31 may be made of materials having larger manufacturing tolerances because the present invention ensures that the variations at the metering interface 39 do not adversely affect the operation of the dispensing gun. Additionally, the body 10 of the dispensing gun may now be made of various materials, such as plastic and composites, that too have a larger manufacturing tolerance, without the need for costly secondary manufacturing techniques currently required to produce dispensing guns.

Although the present invention has been described with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

I claim:

1. A dispensing gun, comprising:
a body;
a passageway formed in the body;
an inlet at an upstream end of the passageway;
a valve seat at a downstream end of the passageway;
a valve member engaging the valve seat at a metering interface; and
a seal blocking the passageway downstream of the metering interface when the valve member is in a closed position.

2. A dispensing gun in accordance with claim 1 wherein the seal is formed in the passageway.

3. A dispensing gun in accordance with claim 1 further comprising a portion extending downstream of the metering interface; and
wherein the seal is disposed between the metering interface and the portion extending downstream of the metering interface.

4. A dispensing gun in accordance with claim 3 wherein the seal comprises a O-ring seated in a metering recess formed in the valve member.

5. A dispensing gun in accordance with claim 4, further comprising:
an internal passage formed in the valve member that is in fluid communication with the inlet and terminating in a port disposed upstream of the metering interface;
a downstream seal blocking the passageway disposed upstream of the port; and
an upstream seal blocking the passageway disposed upstream of the downstream seal.

6. A dispensing gun in accordance with claim 5, wherein:
the downstream seal comprises a downstream O-ring seated in a downstream recess; and
the upstream seal comprises an upstream O-ring seated in an upstream recess.

7. A dispensing gun, comprising:
a body;
a passageway formed in the body;
an inlet at an upstream end of the passageway;
a metering interface at a downstream end of the passageway; and
a seal blocking the passageway downstream of the metering interface when the metering interface is in a closed position.

8. A dispensing gun in accordance with claim 7, wherein the seal is formed in the passageway.

9. A dispensing gun in accordance with claim 7, wherein the seal is disposed at the downstream end of the metering interface.

10. A dispensing gun in accordance with claim 9, further comprising:
an internal passage formed in a valve member forming part of the metering interface, said internal passageway being in fluid communication with the inlet and terminating in a port that is disposed upstream of the metering interface;
a downstream seal blocking the passageway disposed upstream of the port; and
an upstream seal blocking the passageway disposed upstream of the downstream seal.

11. A dispensing gun in accordance with claim 10 wherein the seal comprises a O-ring seated in a metering recess formed in the valve member.

12. A dispensing gun in accordance with claim 11, wherein:
the downstream seal comprises a downstream O-ring seated in a downstream recess; and
the upstream seal comprises an upstream O-ring seated in an upstream recess.

13. A valve member for use in a dispensing gun, comprising:
a valve body;
a metering portion downstream of the valve body; and
a seal downstream of the valve body.

14. The valve member of claim 13, wherein the seal is disposed downstream of the metering portion.

15. The valve member of claim 14, further comprising:
an internal passage in the valve body terminating in a port disposed upstream of the metering portion;
a downstream seal disposed upstream of the port; and
an upstream seal disposed upstream of the downstream seal.

16. The valve member of claim 15, further comprising:
a portion extending downstream of the metering portion; and
wherein the seal is disposed between the metering portion and the portion extending downstream of the metering portion.

17. The valve member of claim 16, wherein:
an O-ring is seated in a metering recess of the seal;
a downstream O-ring is seated in a downstream recess of the downstream seal; and
an upstream O-ring is seated in an upstream recess of the upstream seal.

18. The valve member of claim 13, wherein:
the valve body has a circular cross-section; and
the metering portion has a circular cross-section that tapers towards the downstream end.

19. The valve member of claim 13, wherein the metering portion has a polygonal cross-section that tapers towards the downstream end.

20. The valve member of claim 13, wherein the valve body includes a necked down portion having a reduced cross-section.
